(19) United States
(12) Patent Application Publication
(10) Pub. No.: US 2024/0263841 A1
(43) Pub. Date: Aug. 8, 2024

(54) SOLAR THERMAL COLLECTOR

(71) Applicant: SOLAR POLAR LIMITED, Peterborough Cambridgeshire (GB)

(72) Inventor: Michael Graham REID, Peterborough (GB)

(21) Appl. No.: 18/682,686

(22) PCT Filed: Aug. 11, 2022
(86) PCT No.: PCT/GB2022/052099

§ 371 Date: Feb. 9, 2024

(30) Foreign Application Priority Data
Aug. 11, 2021 (GB) 2111529.0

(51) Int. Cl. F24S 23/74; F24S 20/30; F24S 23/30; F24S 23/70; F24S 23/79; F24S 80/54

(52) U.S. Cl. CPC F24S 23/74; F24S 20/30; F24S 23/31; F24S 23/79; F24S 23/80; F24S 80/54; F24S 2023/872

(57) ABSTRACT

A solar thermal collector comprises a solar heat collector tube and a Fresnel reflector film configured to focus incident solar light on the solar heat collector tube. A solar thermal collector assembly, a solar thermal collector module, a cooling apparatus, and a solar cooker comprising the solar thermal collector are also provided. Also provided is a use of a Fresnel reflector film for collecting solar thermal energy.

### FIELD OF THE INVENTION

This invention relates to a solar thermal collector, to a heat collector assembly, a heat collector module, a cooling apparatus, and a solar cooker comprising the solar thermal collector. Also provided is a use of a Fresnel reflector film for collecting solar thermal energy. The cooling apparatus is particularly an air cooler, and is applicable to the cooling of air in rooms e.g. as part of an air conditioning system, or the cooling of air in a confined space such as a refrigerator.

### BACKGROUND TO THE INVENTION

Solar thermal collectors collect heat by absorbing sunlight, and are used for applications such as heating water. Some solar thermal collectors are provided with solar concentrators, such as parabolic trough mirrors, which enlarge the capture area of the collector by focusing incident light from a larger area onto the collector.

Many parts of the world that suffer high climatic temperatures, where refrigeration and air conditioning are therefore important, are too remote to have a mains electricity supply. Solar power has the potential to resolve this problem but most solar powered refrigeration systems have the problem that they rely on moving mechanical compressors and other parts that are liable to failure. This makes the existing solar powered systems unsuitable for prolonged use in regions where there is no facility for repair and maintenance. Another problem is that most existing designs are electrically driven and employ photoelectric panels to generate the electricity. Unless provided with electric storage facilities, such designs are unable to function during periods when there is no sunlight. Compounding these problems is often a lack of local skilled maintenance personnel.

A modular cooling apparatus which addresses these problems is provided in WO2010/034992A1. In the cooler of WO2010/034992A1, cooler modules collect solar heat in a solar collector and use it to drive an absorption refrigeration cycle which cools a flow of air. The solar collector of WO2010/034992A1 is formed by evacuated tubes and heat pipes, where each heat pipe has a hot end sealed inside an evacuated tube, and a cold end within a housing of the cooler. The modular design of the WO2010/034992A1 cooler allows multiple cooling modules to be connected together, to increase the cooling capacity of the system.

### SUMMARY OF THE INVENTION

The invention is defined in the appended independent claim, to which reference should now be made. Preferred features of the invention are set out in the dependent claims.

According to a first aspect, the invention provides a solar thermal collector comprising:
a solar heat collector tube; and
a Fresnel reflector film configured to focus incident solar light on the solar heat collector tube.

The Fresnel reflector film which is configured to focus solar light on the solar heat collector tube advantageously concentrates the incident solar light on the solar heat collector tube, and may be termed a Fresnel solar concentrator. The use of a Fresnel reflector film as a solar concentrator enlarges the capture area of the collector, as solar light incident on the area of the film is focused onto the solar heat collector tube. The area of the Fresnel reflector film is greater than that of the tube, so the reflector increases the amount of incident solar light received by the tube.

A Fresnel solar concentrator may advantageously be made smaller and lighter than alternative forms of solar concentrator, such as parabolic mirrors, while providing equivalent performance. This may advantageously make Fresnel solar concentrators particularly suitable for use in off-grid locations or developing countries.

The Fresnel reflector film is preferably a concentrating linear Fresnel reflector, and the Fresnel reflector film is preferably configured to focus solar light along a focal line on which the solar heat collector tube is positioned.

In a particularly preferred embodiment, the Fresnel reflector film comprises a Fresnel embossed film, which may be termed a printed Fresnel film or a printed Fresnel lens. A suitable Fresnel embossed film is disclosed, for example, in WO2019/018307A1. Embossed Fresnel films may comprise an optical element comprising an ultra-thin Fresnel reflector includes a plurality of Fresnel elements formed on a surface of a substrate. Each of the plurality of Fresnel surface elements has an angled facet portion and preferably a shallow or substantially horizontal portion. The Fresnel surface elements can be formed, for example, by a hot stamp or cold transfer method carried out on a polymer substrate.

The use of a Fresnel embossed film may provide significant advantages even over Fresnel reflectors formed from glass, or from an array of separate mirrors or lens elements.

Particularly advantageously, Fresnel embossed films may be provided as thin polymer films having Fresnel elements embossed into the surface of the film. The Fresnel embossed film may therefore advantageously be provided as a flat sheet, with the Fresnel elements contained within the thickness of the sheet. As the position and angles of the Fresnel elements are fixed at all times, no calibration or alignment of Fresnel elements is required when the film is installed, unlike multiple-mirror Fresnel reflectors of the prior art. Such films may advantageously be thin, light and flexible, which leads to significant benefits in transport, ease of installation, and durability compared to alternative solar concentrators such as glass parabolic mirrors, or even Fresnel lenses which comprise glass mirrors or lenses.

The Fresnel embossed film may preferably comprise a Fresnel embossed region with a thickness of between 5 μm and 25 μm.

The Fresnel reflector film may comprise a sheet of polymer film, for example a sheet of polymer film having a thickness of between 0.05 mm and 5 mm, with a Fresnel embossed region arranged on one surface of the film. The Fresnel embossed region preferably comprises a plurality of Fresnel elements embossed into the film's surface. Preferably the polymer film may have a thickness of between 25 μm and 200 μm, or between 50 μm and 100 μm. The depth of the embossed Fresnel elements (and therefore the thickness of the embossed region) may preferably be between 5 μm and 25 μm, or between 10 μm and 20 μm.

The Fresnel reflector film may be adhered to one or more layers of glass and or plastic, which may advantageously improve the rigidity of the film, and ensure that the Fresnel elements of the film are positioned correctly to focus light on the solar collector tube. For example, the Fresnel reflector film may be attached to the surface of a transparent glass or plastic backing sheet.

The Fresnel reflector film may be covered by a transparent layer of glass (or polymer), the layer of glass being positioned above the Fresnel reflector film. The layer of glass or plastic may be positioned between the Fresnel reflector film and the solar heat collector tube. The glass may advantageously protect the Fresnel film from rain and dirt which may be accumulated over the lifetime of the collector, while allowing solar light to pass through the transparent layer to arrive at the Fresnel reflector. Parabolic reflectors and Fresnel mirrors are quite difficult to keep clean and their effectiveness is diminished by the fouling. The use of a simple glass sheet in the way described in this invention allows easy cleaning or additionally anti-fouling or self-cleaning glass.

The Fresnel reflector film may preferably be bonded to the layer of glass by optically transparent adhesive.

One side of the Fresnel reflector film preferably comprises a reflective coating, or a reflective layer. The reflective coating may preferably be provided on the surface of the Fresnel elements, such that the reflective surface follows the shape of the Fresnel elements. In a preferred embodiment the reflective layer consists of aluminium.

The collector is configured with the Fresnel reflector film as a Fresnel reflector configured to reflect incident solar light and focus it on the solar collector tube.

The Fresnel reflector film preferably has a focal length of between 120 mm and 300 mm, preferably between 140 mm and 250 mm, particularly preferably between 150 mm and 220 mm. Particularly preferably the Fresnel lens may have a focal length of around 180 mm. Focal lengths in this range may be particularly suitable for solar cooling apparatuses configured for installation on domestic buildings.

The solar heat collector tube is preferably an evacuated tube.

Preferably the or each evacuated tube has a diameter of between 50 mm and 80 mm, preferably between 55 mm and 75 mm. Many prior art heat collection apparatuses have typically used evacuated tubes with a diameter of 100 mm, the large diameter of which was required in order to absorb enough heat for the desired purpose. By using the Fresnel reflector film to concentrate solar power, however, the same amount of heat may be absorbed by a smaller diameter tube, such as an evacuated tube having a diameter of 58 mm or 75 mm. Evacuated tubes having smaller diameters are advantageously cheaper to manufacture and transport, making the solar thermal collector more cost effective and portable.

In some embodiments, the collector may comprise a secondary concentrator configured to focus incident light on the solar heat collector tube, the secondary concentrator being positioned on the opposite side of the solar heat collector tube to the Fresnel reflector film. For example, the Fresnel reflector film described above may be the primary solar concentrator, which focuses light on the solar heat collector tube, and the secondary concentrator may be positioned on the other side of the solar heat collector tube, so that the secondary concentrator collects any concentrated light that passes the solar heat collector tube, and reflects it back to the solar heat collector. This may advantageously increase the proportion of incident solar light that is absorbed by the collector tube.

In a preferred embodiment the secondary concentrator comprises a second Fresnel reflector film configured to reflect and focus light on the solar heat collector tube.

The collector may comprise a solar tracking system configured to track the position of the sun and adjust the position of the Fresnel reflector film in response to the changing position of the sun throughout the day. The solar tracking system may be configured to maintain the position of the Fresnel reflector film at an angle of 90 degrees to the incident sunlight, and/or to maintain the solar heat collector tube at the focal point of the Fresnel reflector film.

The solar heat collector is advantageously usable for a variety of different applications which require an input of heat energy.

A working fluid is preferably passed through the interior of the solar heat collector tube, to absorb the collected heat and to transfer that heat out of the solar heat collector tube for use.

The collector preferably comprises a heat vector which is arranged to receive heat from the solar heat collector tube, and to transfer the received heat out of the collector, preferably to a heat-receiving device. In a first preferred embodiment, the heat vector may be a two-phase thermosyphon. In an alternative preferred embodiment, the heat vector may be a hot water loop. The two-phase thermosyphon may be preferred for high temperatures, while the hot water loop is preferred for temperatures below 100° C.

In a preferred embodiment, the solar heat collector tube is configured to heat a working fluid in a two-phase thermosyphon loop, the two-phase thermosyphon loop being configured for transferring the collected heat to a heat-receiving device. The two-phase thermosyphon loop is preferably configured to supply the heat-absorbing working fluid to the interior of the solar heat collector tube, where the working fluid is heated and changes phase by evaporating, to direct the evaporated working fluid to the heat-receiving device, where the working fluid condenses and transfers heat to the heat-receiving device, before returning the condensed working fluid to the interior of the solar heat collector tube for re-heating.

The working fluid in the two-phase thermosyphon may preferably be water. Alternatively, the working fluid may comprise liquid CO₂, ammonia or hydrocarbons.

The two-phase thermosyphon may, for example, be configured to provide heat to a solar cooker apparatus.

In another preferred embodiment, the working fluid may be water, so that the solar heat collector tube contains a water pipe, and is configured to heat water flowing through the water pipe. The water pipe is preferably configured to provide a supply of cool water to the interior of the solar heat collector tube, where it is heated to a high temperature, and to direct the heated water out of the collector tube. In a preferred embodiment, the heated water may be circulated in a closed loop and returned to the interior of the solar heat collector tube for re-heating. Alternatively the heated water may be diverted out of the collector for use, and a supply of cool fresh water may be provided to the water pipe in the solar heat collector tube. For example the heated water may be used in a domestic heating loop or in a hot water system.

In some embodiments, solar thermal collector may comprise a plurality of Fresnel reflector films and/or a plurality of solar heat collector tubes. The plurality of solar heat collector tubes may optionally be configured to transfer heat to the same heat-receiving device.

The solar thermal collector preferably comprises, or is mountable to, a frame configured to suspend the solar heat collector tube above the Fresnel reflector film, as described below in relation to the second aspect.

According to a second aspect, the invention may provide a solar thermal collector assembly, comprising:
a solar thermal collector according to the first aspect of the invention, and
a frame configured to suspend the solar heat collector tube above the Fresnel reflector film.

The solar heat collector tube may be supported above the Fresnel reflector film by a frame which comprises a pair of end support brackets configured to suspend the ends of the evacuated solar heat collector tube at a predetermined height above the Fresnel reflector film. The frame preferably also comprises a tray which extends between the two end brackets, and which forms a recess in which the Fresnel reflector film may be positioned.

The tray is preferably configured so that an upper surface of a glass layer covering the Fresnel reflector film is situated flush with a top lip of the tray, such that rainwater will wash away dust, dirt and debris.

According to a third aspect of the invention there may be provided a solar thermal collector module, comprising an array of such solar thermal collector assemblies. The solar thermal collector module may preferably comprise a chassis, or module frame, on which a plurality of heat collector assemblies are mountable. The chassis may be configured to support the array of solar thermal collector modules at a predetermined angle relative to the ground, or the angle of the chassis may be adjustable.

The module may comprise a pipe manifold configured to transport working fluid to and from the interior of the heat collector tubes of the heat collector assemblies. The module may comprise an insulated manifold cover configured to insulate the pipe manifold serving a row of assemblies in the array.

Adjacent solar thermal collector assemblies may be arranged end-to-end and/or side-by-side in the array. A variety of configurations of the array are possible, with different numbers of heat collector assemblies arranged in rows next to one another.

In a particularly preferred embodiment a solar thermal collector module may comprise two rows of solar thermal collector assemblies, in which pairs of adjacent solar thermal collector assemblies are positioned end-to-end such that the solar heat collector tubes of the assemblies are aligned along a common axis. Preferably the pipe manifolds of the two rows of solar thermal collector assemblies are located at the outer edges of the array. Advantages of such an arrangement are discussed below in relation to the Figures.

The solar thermal collector module may comprise one or more fasteners for fastening together the frames of adjacent heat collector assemblies in the array.

According to a fourth aspect, the invention provides a cooling apparatus comprising: solar thermal collector according to the first aspect of the invention described above; and one or more absorption refrigeration modules, each module being arranged to receive heat from the solar heat collector for driving an absorption refrigeration cooling cycle.

The use of the Fresnel reflector film may advantageously increase the solar power received by the solar heat collector tube, and therefore increase the efficiency of heat collection. By focusing solar power on the heat collector, the Fresnel reflector film may also increase the temperature of the solar heat collector tube. This may advantageously mean that the solar heat collector tube is capable of driving the absorption refrigeration cooling cycle with less incident solar light than has previously been possible in the prior art. For example the temperature required to drive the cooling cycle may be achieved earlier in the day, and allow cooling to be provided in a wider range of light and weather conditions. The solar power concentration may also allow the use of fewer solar heat collectors per cooling module, or smaller solar heat collectors, while still collecting enough solar power to drive the absorption refrigeration cooling cycle.

Advantageously the cooling cycle works more efficiently when supplied with the higher temperatures enabled by the Fresnel concentrator film.

A Fresnel reflector film may advantageously be made smaller and lighter than alternative forms of solar concentrator, such as parabolic mirrors, while providing equivalent performance. This advantageously makes Fresnel solar concentrators particularly suitable for use with absorption refrigeration modules designed for use in off-grid locations or developing countries.

For heat supply to absorption-refrigeration modules, the use of a Fresnel embossed film provides significant advantages even over linear Fresnel reflectors formed from an array of separate mirrors.

The Fresnel reflector film may advantageously be provided as a flat sheet, with the Fresnel elements contained within the thickness of the sheet. As the position and angles of the Fresnel elements are fixed at all times, no calibration or alignment of Fresnel elements is required when the film is installed, unlike multiple-mirror Fresnel reflectors of the prior art. Such films may advantageously be thin, light and flexible, which leads to significant benefits in transport, ease of installation, and durability compared to alternative solar concentrators such as glass parabolic mirrors, or even Fresnel lenses which comprise glass mirrors or lenses.

For off-grid and/or roof-mounted absorption-refrigeration modules, the improved portability and durability of Fresnel reflector films are significant improvements over prior art solar concentrators such as parabolic mirrors. Parabolic mirrors and rigid mirror arrays can suffer from problems with moving and flexing in wind, so for roof-mounted absorption-refrigeration cooling modules, the flat Fresnel reflector films are more reliable and suffer from fewer calibration difficulties. The use of a Fresnel reflector film is preferred over a transmissive Fresnel lens, as shorter focal lengths are possible, so that the apparatus may advantageously be made simpler and more compact.

The Fresnel lens used with the cooling apparatus may preferably have a focal length of between 120 mm and 300 mm, preferably between 140 mm and 250 mm, particularly preferably between 150 mm and 220 mm. Particularly preferably the Fresnel lens may have a focal length of around 180 mm. Focal lengths in this range may be particularly suitable for solar cooling apparatuses configured for installation on domestic buildings.

The apparatus may comprise one or more evacuated tubes for solar heat collection. For example, each absorption refrigeration module may be arranged to receive heat from a plurality of evacuated tubes. The evacuated tubes may be arranged, for example, side-by-side, or in bundles of three tubes connected together in a pyramidal arrangement.

Preferably the or each evacuated tube has a diameter of between 50 mm and 80 mm, preferably between 55 mm and 75 mm. Conventional prior art apparatuses such as those disclosed in WO2010/034992A1 have typically used evacuated tubes with a diameter of 100 mm, the large diameter of which was required in order to absorb enough heat to drive the refrigeration cycle. By using the Fresnel solar concentrator, however, the required heat may be absorbed by a smaller diameter tube, such as an evacuated tube having a diameter of 58 mm or 75 mm. Evacuated tubes having smaller diameters are advantageously cheaper to manufacture and transport, making the apparatus more cost effective and more suitable for installation in developing countries.

Preferably each module is configured to cool air in an air conditioning system.

In alternative embodiments, each module of the cooling apparatus is arranged to cool air within an enclosed refrigerator cabinet, or to cool air within an ice-maker.

The apparatus comprises one or more absorption refrigeration modules, each module being arranged to receive heat from the one or more solar heat collector tubes for driving an absorption refrigeration cooling cycle. The absorption refrigeration cycle may be operated according to known processes, for example as described in WO2010/034992A1.

Each module is preferably arranged to receive heat from the solar heat collector and to re-circulate refrigerant through an evaporator. Each module preferably also comprises means for putting a fluid to be cooled (preferably air to be cooled) into thermal contact with each of the evaporators.

Each module preferably incorporates its own individual evaporator. A housing for this, defining a path for air to be cooled, can conveniently be formed by partition walls within a main outer casing of the module. In one particularly effective design, the outer casing of each module is formed with ports that allow interconnection between the evaporator housings of adjoining modules, so that the air being cooled can flow between adjoining modules.

In a preferred embodiment, the apparatus may have a single air inlet for air to be cooled, and a single air outlet through which cooled air is delivered to the space to be cooled. Thus, the evaporator housings of multiple modules may be connected to one another, but a single inlet and outlet may be shared by all of the connected modules.

By employing a modular construction it becomes possible to obtain any desired cooling power by employing any appropriate number of modules. Furthermore, by using absorption refrigeration principles the invention makes it possible to eliminate the need for moving parts, allowing the system to function for many years without maintenance.

Each module of the cooling apparatus may comprise
a. a generator containing a solution of refrigerant in a liquid, the generator being arranged to receive heat from the heat collector and to cause evaporation of the refrigerant,
b. a bubble pump for pumping the liquid from the generator to an absorber,
c. a condenser arranged to receive gaseous refrigerant from the generator and to condense the same,
d. an evaporator,
e. means for passing liquid refrigerant from the condenser to the evaporator, and
f. absorbing means for receiving gaseous refrigerant from the evaporator, absorbing it into the liquid from the bubble pump and returning the liquid to the generator.

Preferably each module comprises a heat pipe, the heat pipe being configured to transfer heat from the solar heat collector to the generator. Preferably the heat pipe and the generator are in thermal contact via a heat store comprising a phase-change material. In a preferred embodiment the phase-change material is water.

Alternatively each module may be arranged to receive heat from a two-phase thermosyphon loop which is itself arranged to receive heat from the solar heat collector tube. Part of the loop preferably passes through the interior of the solar heat collector tube, while the other end of the loop is configured to transfer heat to the generator of the cooler module.

Preferably the refrigerant is ammonia.

Bubble pumps rely on surface tension to operate and are for that reason not scalable to larger sizes. If the diameter of the tube of the bubble pump exceeds around 12 mm, then the meniscus will be prone to collapse. This limits the amount of cooling a bubble pump driven system can deliver. The invention makes it possible to provide any desired amount of cooling by using a plurality of modules. Each module preferably comprises only a single bubble pump.

The modular configuration proposed by the invention also gives economies of manufacturing and distribution costs. This is because only one module design is required, which can be produced in large quantities and assembled in banks of different sizes depending on the power requirements of a particular situation. Typically a residential property might require 8 to 15 modules for air conditioning purposes whilst a refrigerator might require just one module.

The use of Fresnel reflector films to concentrate incoming solar light on the solar heat collector tube may advantageously significantly increase the solar power received by the solar heat collector compared to the prior art design of WO2010/034992A1. This may advantageously increase the temperature of the hot end of the heat pipe, so that the absorption refrigeration cycle may operate in less-sunny conditions, and/or at lower ambient temperatures, than has previously been possible.

It would be possible for the generator to be included within, or in direct contact with, the solar collector but this is not preferred because it would be difficult, without recourse to powered fans or the like, to ensure that heat is efficiently transferred to the generator. In a preferred embodiment, a heat pipe is provided and configured with its hot end in thermal contact with the solar heat collector. The cold end of the heat pipe and the generator can then be arranged in thermal contact with each other. In a preferred arrangement the thermal contact is achieved by a phase-change heat storage medium, the cold end of the heat pipe and the generator preferably being in close thermal contact with (but preferably not immersed in) this medium. Heat stored in the phase change heat storage medium is able to drive the refrigeration system into the evening after sunset.

Each module preferably has a casing which encloses some or all of the components (a) to (f) listed above and includes means for fastening the modules rigidly together, for example one or more fasteners. The fasteners are preferably in the form of clips or other fastening devices that permit easy assembly. It is best if the casing has parallel sides that are flat or otherwise shaped so as to conform to each other so that the sides of adjacent modules lie against each other when attached.

Each module preferably comprises an evaporator housing, which houses the evaporator. The evaporator housing preferably defines a path for air to be cooled, so that the air to be cooled comes into contact with the evaporator inside the evaporator housing. The evaporator housings of adjacent modules are preferably connectable via ports so that the air being cooled can flow between the evaporator housings of multiple modules. The connected modules must have at least one inlet to allow hot air into the evaporator housing(s), and at least one outlet to allow cooled air to flow out of the evaporator housing(s) into the space to be cooled.

The invention can be used for cooling air in an air conditioning system, where there is normally a need for continued operation into the evening but not throughout the night. When the system is for use in air conditioning, the modules are preferably installed in a roof space or, for a flat-roofed building, on top of the roof.

The invention is also applicable to refrigeration systems for storage of food or medicines. In such a system, since the space to be cooled is relatively small, the stored latent heat of the phase change material may be sufficient to last throughout the night or at least for sufficient time to ensure that the temperature of air within the relevant space does not rise unacceptably. When for use as a refrigerator, the modules are preferably mounted on an outside panel, e.g. a panel defining the top surface of the cabinet.

The cooling apparatus is not limited to environments where it is used for cooling air. It could be used for cooling liquids such as drinks; and fluids that require cooling in industrial processes.

According to a fifth aspect of the present invention there is provided a solar cooker, comprising a solar thermal collector according to the first aspect of the invention, and a container for food, in which the solar cooker is configured to heat the container with heat from the solar heat collector tube.

The container may preferably be a double-walled container enclosing an interior volume between the walls. The interior volume of the container is preferably in fluid communication with the solar heat collector tube, so that a heat-transfer medium heated in the solar heat collector tube is transferred in a loop through the interior volume of the container and back to the solar heat collector tube.

The heat-transfer loop between the interior volume of the container and the interior of the solar heat collector tube may preferably comprise a two-phase thermosyphon.

Other applications include stills and in particular desalination distillation.

The container is preferably insulated.

According to a sixth aspect of the invention, there is provided a method method of use of a Fresnel reflector film to collect solar thermal energy in a solar thermal collector. Preferably, the Fresnel reflector film is used to focus incident solar light onto a solar heat collector tube. The Fresnel reflector film is preferably a Fresnel reflector film as described above in relation to the first aspect of the invention.

Features described in relation to one aspect of the invention are combinable with all other aspects of the invention described herein.

### BRIEF DESCRIPTION OF THE DRAWINGS

One way in which the invention may be performed will now be described by way of example with reference to the accompanying drawings in which:

FIG. 1a is a schematic perspective view of a Fresnel reflector and solar heat collector tube according to the present invention;

FIG. 1b is a schematic cross-section of the Fresnel reflector film and solar heat collector tube of FIG. 1a;

FIG. 1c is an enlarged view of the Fresnel reflector film of FIGS. 1a and 1b;

FIG. 1d is a further enlarged view of FIG. 1c;

FIG. 1e is a graph showing the temperatures reached by a 58 mm-diameter 500 mm long evacuated solar collector tube with and without solar concentration by a Fresnel reflector film;

FIG. 1f is a schematic cross-section of an alternative Fresnel reflector film and three-tube solar heat collector;

FIG. 2 is a schematic illustration of the components of an air conditioning system constructed in accordance with an aspect of the invention;

FIG. 3 shows a vertical cross-section through a house having a pitched roof and fitted with the system of FIG. 2;

FIG. 4 is a perspective view of a solar heat-collection apparatus and a cooler module into which most of the other components shown in FIG. 2 are contained;

FIG. 5 shows a variation of the module design for use on a flat roof or on a rectilinear cabinet for use as a refrigerator; and

FIG. 6 shows a perspective view of a group of similar modules connected in parallel;

FIG. 7a is a schematic illustration of a two-phase thermosyphon usable with a cooling apparatus in accordance with the invention;

FIG. 7b is a schematic flow diagram of a three-tube solar heat collector based on the thermosyphon of FIG. 7a;

FIG. 8 shows a solar cooker device suitable for use with the solar thermal collector of the present invention;

FIG. 9a shows a schematic side view of a heat collector assembly comprising a Fresnel reflector and a solar heat collector tube;

FIG. 9b shows a schematic top view of the heat collector assembly of FIG. 9a;

FIGS. 9c and 9d show schematic end views of the heat collector assembly of FIGS. 9a and 9b;

FIG. 20 is a partial end view of a heat collector module comprising an array of heat collector assemblies according to the present invention, mounted on a module chassis;

FIG. 11 is a schematic view of three modules, each comprising four heat collector assemblies;

FIG. 12 is a schematic top view of two heat collector assemblies arranged end to end;

FIG. 13a is a schematic view of a heat collector assembly comprising a Fresnel reflector and solar heat collector tube, showing incident solar rays; and

FIG. 13b is a schematic view of two of the heat collector assemblies of FIG. 13a arranged end to end.

### DETAILED DESCRIPTION

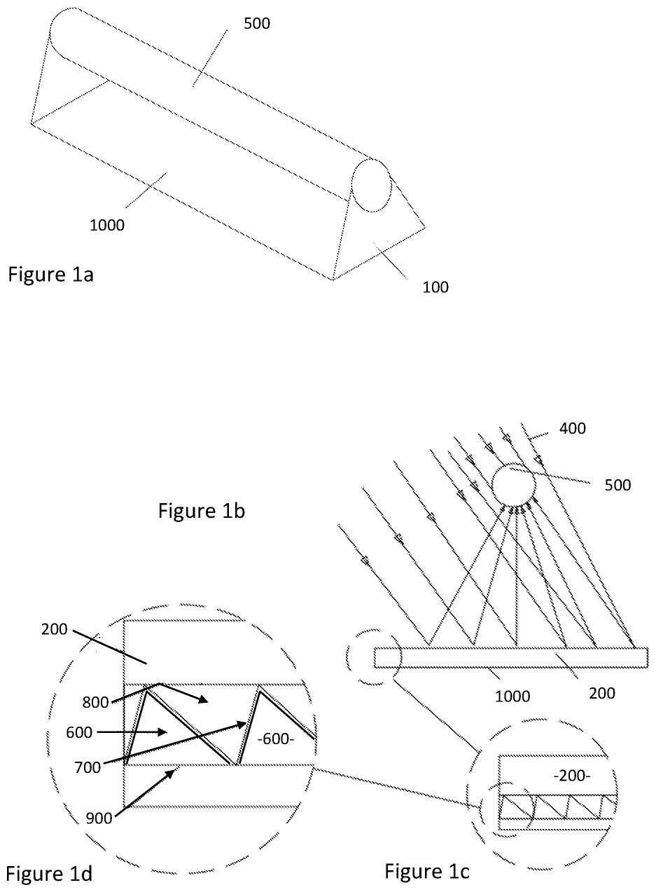

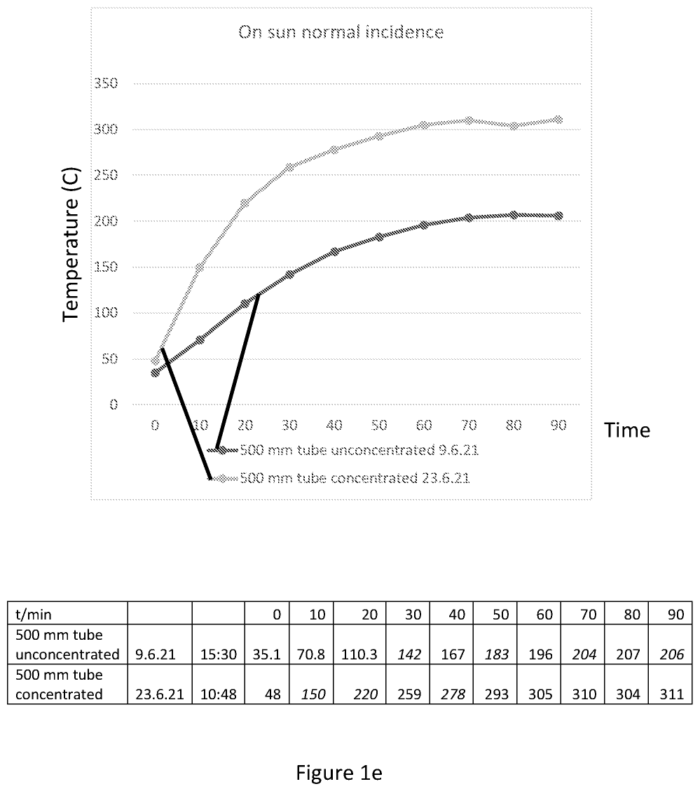

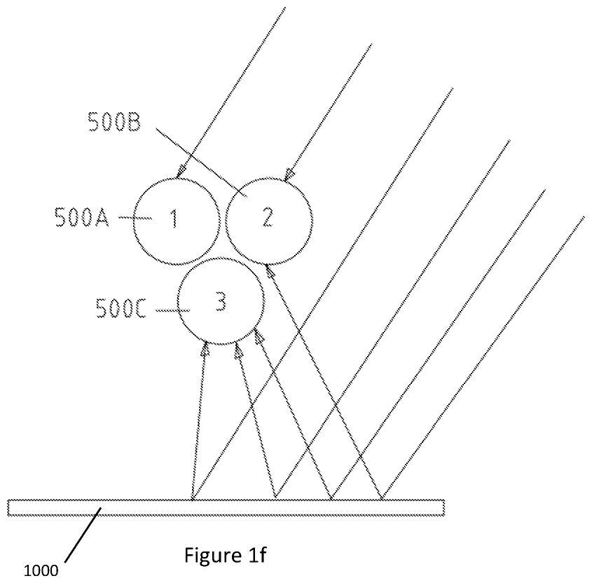

FIGS. 1a-1d are schematic illustrations of a Fresnel reflector and solar heat collector tube usable in a preferred embodiment of the present invention.

An evacuated solar collector tube 500 of the type commonly used to collect solar heat for solar hot water systems is used as a solar heat collector, which is suspended above a Fresnel reflector by a mount 100.

The Fresnel reflector 1000 is a multi-layer structure formed from a Fresnel reflector film attached to the underside of a transparent glass sheet 200 with optically clear adhesive 800. The Fresnel reflector film consists of a Fresnel embossed film which is “printed” onto a flexible backing sheet 900 and coated in a reflective layer 700. The Fresnel embossed film comprises a series of Fresnel elements 600 formed from angled surfaces embossed into the top surface of the backing sheet 900. The reflective layer 700 (which may be formed from aluminium for example) deposited on the surface of the embossed Fresnel elements 600. The shape of the reflective layer 700 takes the form of the embossed Fresnel elements underneath, so that each Fresnel element becomes reflective. The layered structure then acts as a mirror, as incident solar light enters through the transparent glass sheet 200, and reflects off the reflective layer 700. As the reflective layer 700 takes the form of the Fresnel elements, the reflected light is focused to the focal point of the Fresnel reflector film.

The Fresnel embossed film contains a series of Fresnel optical elements including multiple angled facets, which are configured to refract incident light so that the embossed film acts as a linear Fresnel reflector according to known principles. The Fresnel optical elements are oriented to run lengthways along the reflector, to focus light along a focal line on which the solar heat collector tube 500 is positioned.

In a preferred embodiment, the backing sheet 900 has a thickness of 50 μm and the Fresnel elements 600 are embossed into a 10 μm-thick embossed portion on the surface of the backing sheet.

The Fresnel embossed film may be produced using a method of WO2019/018307A1, for example. In the preferred embodiment shown, the Fresnel embossed film is formed by trapping a clear resin between the backing sheet 900 and a roller engraved with the negative form of the Fresnel mirror, and allowing the resin to set in contact with the roller, to form Fresnel elements 600.

As shown in FIG. 1b, incident solar light (sunlight) 400 falling on the Fresnel mirror 1000 is reflected by the Fresnel mirror and concentrated onto the solar heat collector 500.

The Fresnel reflector reflects sunlight onto the solar heat collector tube 500 for a wide range of angles of incidence. The reflective properties of the Fresnel reflector are therefore analogous to conventional trough mirrors, such as those manufactured and sold by Artic Solar Inc.

The Fresnel reflector film of the present invention allows sunshine to be collected and concentrated to produce elevated temperatures at the solar heat collector tube 500. These Particularly advantageously, these Fresnel reflector films and solar heat collector tubes can therefore be used to produce elevated temperatures required for applications such as solar cooking, domestic hot water systems, solar stills, solar kilns, or to drive ammonia-water absorption-refrigeration cycles.

Advantageously these Fresnel reflector films produce the same solar-concentration performance as rigid trough reflectors but at a fraction of the production cost. The Fresnel reflector films also product similar performance to known linear Fresnel solar concentrators formed from arrays of rigid mirrors, while providing a far more compact, affordable and pre-calibrated solution, which is not susceptible to problems created by wind, even when mounted on exposed rooftops.

FIG. 1e shows the temperatures reached by a 58 mm-diameter evacuated solar collector tube both with no solar concentrator, and with solar concentration by a Fresnel reflector film. In this graph, the higher temperature results for the “500 long mm tube concentrator” were captured from the apparatus shown schematically in FIGS. 1a-1d, in which a rectangular linear Fresnel reflector film was positioned at a focal distance of 160 mm from the axis of an evacuated collector tube. The apparatus was shifted normal to the sun every ten minutes during testing, though the apparatus may alternatively be kept stationary throughout the day.

FIG. 1e shows that using the Fresnel reflector film of the present invention allowed a 58 mm diameter, 500 mm long, evacuated tube to reach a temperature of over 300° C. after around 60 minutes in the sun. This is far higher than the 200° C. reached by the same tube without the use of a Fresnel reflector film to concentrate incident solar light on the tube.

FIG. 1f illustrates an alternative embodiment of a solar heat collector usable with the present invention. In this embodiment, three solar heat collector tubes 500 are bundled together in a pyramidal arrangement above a Fresnel reflector film as described above. As the three-tube solar heat collector occupies more space than a single tube, the tubes receive more direct solar light. As the angle of the sun changes during the day, the focal point of the Fresnel reflector may move, so the larger bundle of tubes ensures that the concentrated solar light is focused on at least one of the three tubes throughout the day.

Each collector tube 500 is an evacuated tube with a double wall (like a vacuum flask). The collector tubes work by the greenhouse effect so as sunshine falls on the collector tube 500 the internal temperature rises, and the interior gains heat. There is some loss of heat from the interior of the tube due to the inner wall radiating in the infrared and that heats up the outer wall.

As the collector tube 500 gets hotter, the rate of heat gain from the sun stays the same but the rate of loss goes up until the two rates become equal. At that point the temperature of the evacuated tube 500 stops rising and stays at what is known as the stagnation temperature.

In the three-tube configuration illustrated in FIG. 1f, the top two tubes (labelled 500A and 500B in FIG. 1f) gain heat directly from the sun and also receive the radiated heat lost from the lower tube (labelled 500C in FIG. 1f), thus slowing the net rate of heat loss from the lower tube 500C. This means that the lower tube 500C will have a higher stagnation temperature than could be achieved with a single tube collector.

As the three-tube configuration of collector tubes 500 increases the overall stagnation temperature of the solar heat collector, this arrangement allows solar power to be collected more efficiently, and optionally smaller-diameter evacuated tubes 500 may be used.

Though not shown in FIGS. 1a-1f, the solar heat collector tubes 5, 500 are configured to transfer heat to a heat vector, so that the heat collected in the tubes can be transferred elsewhere for use. In preferred embodiments, one or more pipes passes into the interior of the tubes through a seal, so that a heat vector may be passed through the pipes to absorb the heat inside the evacuated tubes.

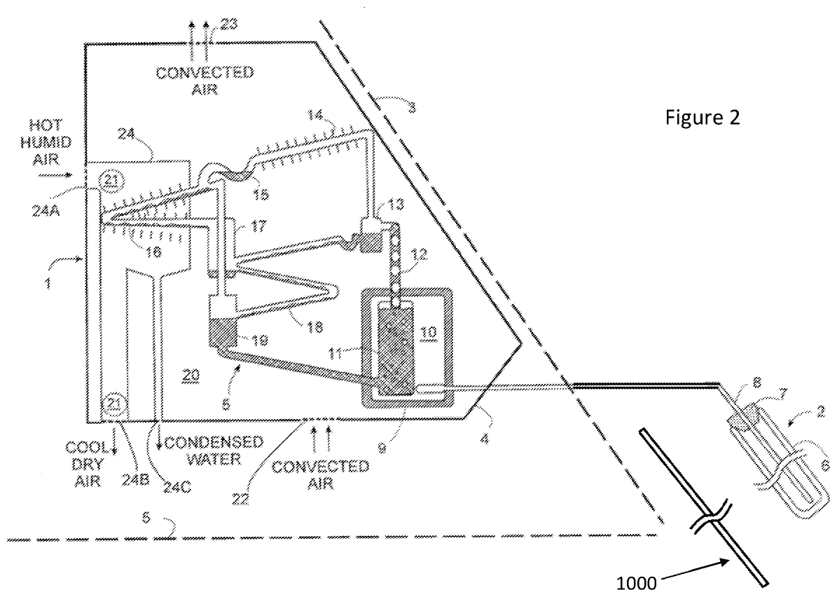

FIGS. 2 to 6 illustrate an exemplary absorption-refrigeration cooling apparatus that may be used with one or more Fresnel solar concentrators in an aspect of the present invention.

Referring firstly to FIG. 2, there is shown a refrigeration module 1 comprising a solar collector 2 exposed to sunlight on the outside of a roof 3 of a building and a housing 4 mounted inside a roof space defined between the roof 3 and a ceiling 5. The solar collector 2 is formed by three evacuated tubes 6 (only one shown for simplicity of description) each having a seal 7. Arrangements having a different number of tubes 6, e.g. two or four would also be suitable.

The module 1 also includes heat pipes 8, one for each collector 2, containing, in this particular example, water as its operating fluid. The pressure inside the heat pipe varies so that it is always at the saturation pressure for any given temperature. In this example, the heat pipe reaches around 220° C., at which point the pressure inside the heat pipe is well above ambient pressure. The hot end of each heat pipe is located within the heat collector tube and it passes through the seal 7 and through the roof 3 to its cold end within the housing 4.

Fresnel reflectors 1000 like those described in relation to FIGS. 1a-1d are configured to reflect and focus incident sunlight onto the evacuated tubes 6. This significantly increases the temperature of the hot ends of the heat pipes compared to equivalent systems without Fresnel concentrators, allowing the absorption-refrigeration cycle to operate over a wider range of sunlight conditions.

A heat store is formed by an insulated vessel 9 containing a phase-change material 10. In this example the phase change material is a eutectic mixture of sodium nitrate and lithium nitrate, having a melting point of 195° C. Other materials having melting points in the range of 190° C. and 220° C. would also be suitable for use with an ammonia solution refrigerant. The heat pipe 8 passes through the wall of the heat store vessel 9 so that its colder end is in close thermal contact with the phase-change material 10.

A generator 11, containing strong ammonia solution in water, is in close thermal contact with the phase-change material 10 and is connected via a bubble pump 12 and collector 13 to a condenser 14, a trap 15, an evaporator 16, a junction 17, a heat exchanger 18 and a reservoir 19.

Ammonia is the refrigerant and has a boiling point of around 190° C. For optimal operation the phase change material should have a melting point above, but within 20° C. of, the boiling point of the refrigerant.

The use of the Fresnel reflectors 1000 significantly concentrates the solar power received by the evacuated tubes, and therefore allows the system to reach the boiling point of ammonia more quickly, and/or with less incident sunlight.

The housing 4 is formed from pressed metal sheet and defines an air duct 20.

The evaporator 16 is located in a heat exchange chamber 24 where hot air drawn through port 24A is cooled and flows by convection down through port 24B into a living area of the building. The heat exchange chamber is defined between side walls of the housing 4 and partition walls as shown in FIG. 1. These partition walls extend downwardly towards an exit 24B for cool dry air and an exit port 24C for condensed water. The latter can be drained away via a flexible pipe (not shown).

The housing is formed with holes 22 and 23 and with ports 21, 24A and 24B that can be closed off or left open as required. Ports 21 are formed on opposite parallel vertical faces of the housing 4 in the region of the heat exchange chamber 24. In a single module system just ports 24A and 24B are left open, to form an inlet to allow entry of air to be cooled into the heat exchange chamber 24, and an outlet to allow exit of cooled air from it.

Where additional modules are connected to the first module, the ports 21 of all adjoining modules are aligned so that the heat exchange chambers 24 of all modules are connected, while sharing a common entry and exit 24A and 24B each respectively provided by just one of the modules.

In an alternative embodiment, an evaporator housing 24 may enclose the heat exchange chamber and the evaporator 16, while the other components may not be contained in a housing. The evaporator housings 24 of adjacent modules may advantageously be connected to one another by ports 21 in the walls of the evaporator housings.

It is necessary to heat the generator 11 to a temperature of about 230° C. to start the refrigeration cycle but, once started, it will continue to operate unless the temperature of the generator 11 drops to about 190° C. or below. Operation is as follows.

Sunlight during the day is incident on the Fresnel reflector 100, and is reflected and concentrated onto the evacuated tubes 6, so that the concentrated solar power heats the hot, lower, end of the heat pipe 8. The pipe 8 contains water, which acts as a refrigerant. The resulting water vapour rises to the upper, relatively cold, end of the heat pipe, where it condenses, giving up its heat to the phase change material 10.

The temperature of the phase change material increases until it reaches its phase change temperature of 200° C. at which point it remains at that temperature whilst continuing to absorb heat from the heat pipe as it changes phase. When the phase change material has become entirely liquid, its temperature continues to rise again until it reaches 230° C., the start-up temperature of the refrigeration system. The refrigeration system then starts to operate and the temperature of the phase change material drops, say to 210° C., as the heat is drawn from it to drive the refrigeration system.

The refrigeration cycle itself is entirely conventional in operating principles as follows.

The generator 11 contains a strong solution of ammonia in water. Heat from the phase change material boils the solution, releasing bubbles of ammonia gas and resulting in weakening of the solution. The bubbles raise the weakened solution to the separator 13 by the action of the bubble pump 12.

In the separator 13, the ammonia gas is separated from the weak ammonia solution and travels to the condenser 14 where heat is released to the air in duct 20 causing the ammonia gas to condense as liquid ammonia. The latter passes through trap 15 into the evaporator where it is exposed to hydrogen gas. The hydrogen environment lowers the vapour pressure of the liquid ammonia sufficiently to cause the ammonia to evaporate, extracting heat from air in the duct 24. This produces cool, dehumidified air for air conditioning purposes and pure water which exits from port 24C and can be collected for use.

The ammonia gas and hydrogen mixture passes to the mixer 17 where the ammonia dissolves in the weakened solution from the separator 13, producing a more concentrated solution which flows into the heat exchanger 18 where it loses its heat to air within the duct 20. The concentrated solution then passes into the reservoir 19 and thence to the generator 11 whereupon the cycle is complete.

When the power of the sun becomes insufficient to retain the phase change material above 200° C., the latter starts to solidify and the latent heat of fusion maintains the generator 11 at a sufficient temperature to sustain the refrigeration cycle. In this way the refrigeration mechanism can remain operational throughout the night or at least a sufficient part of it to ensure that cooling is maintained until the ambient temperature drops to an acceptable level. A larger volume of phase change material may also be provided in the space below the evaporator 16. This phase change material will solidify when the system is providing cooling during the day but will melt at night, to provide further cooling at night. This can provide cooling for long periods. Indeed a small medicine refrigerator can store five days worth of cooling in this way.

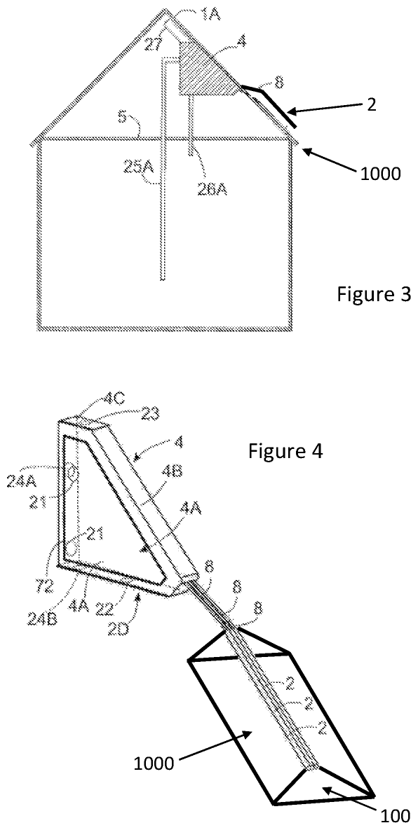

FIG. 3 shows how the various parts that have been described are installed in a building having a pitched roof 3. From this drawing it can be seen that the solar collector 2 lies against the roof surface, on the outside of the building whilst the housings 4 and their contents are in the roof space isolated from the main living area of the building (i.e. the area to be cooled). A chimney 27 connects to the port 23 (or each of the ports where there are multiple modules) to provide improved draft of cooling air.

FIG. 4 shows how the housing 4 is formed with parallel flat faces 4A, a sloping edge 4B arranged parallel to the tubes 2 and to the roof surface so that it can be mounted on the inner face of the roof; a short horizontal top edge 4C formed with vent hole 23 and adapted to be connected to a chimney duct (not shown) and an open relatively long, bottom horizontal edge 2D formed with vent hole 22. The faces 4A have gaskets 72 which provide a seal between adjoining units when they are connected together in the manner described below to give the required power depending on the installation.

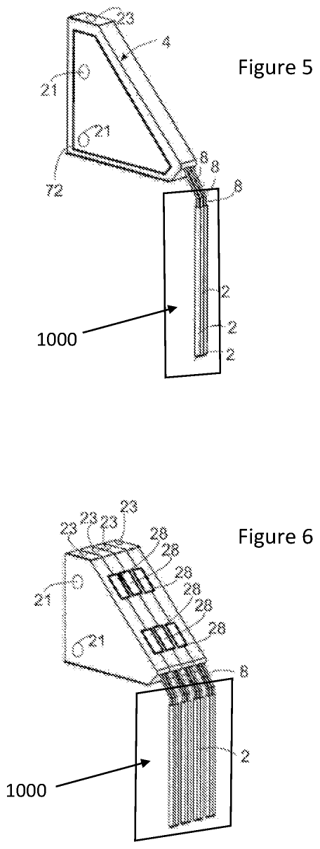

FIG. 5 shows a variation where the tubes 2 are angled so as to be perpendicular to the bottom faces 2D of the modules to permit mounting on a wall. FIG. 5 shows a modular construction comprising a stack of housings connected physically together, face to face by clips 28.

A system as shown in FIG. 5 or 6 can readily be adapted for use as a refrigerator instead of an air conditioning system. In such an arrangement, one or more modules would be mounted on an outer surface (e.g. the top surface) of an insulated cabinet with pipes analogous to those shown at 25A and 26A on FIG. 3 extending through that surface into the cabinet interior so as to circulate and cool air in the cabinet. In this arrangement it is envisaged that the cabinet would normally be located inside a building with the tubes 6 projecting through the outside wall and fixed on and parallel to the outside of the wall to collect solar heat.

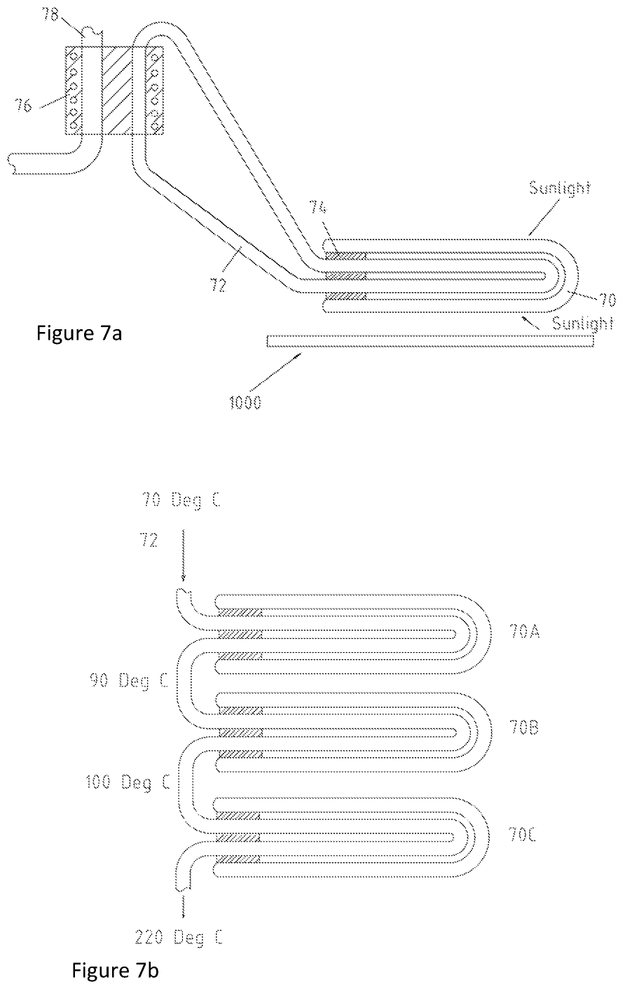

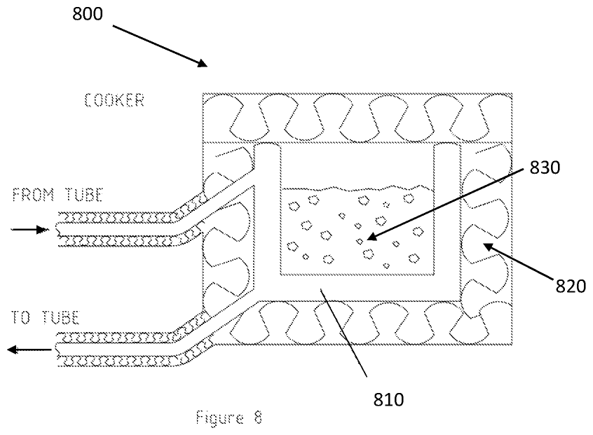

FIG. 7a illustrates a two-phase thermosyphon that may advantageously be used in any embodiment of the present invention to transfer heat from a solar heat collector to a heat-receiving device such as an absorption refrigeration module. The two-phase thermosyphon may take the place of the heat pipe in the embodiment described above. Fresnel reflectors 1000 like those described in relation to FIGS. 1a to 6 are configured to reflect and focus incident sunlight onto an evacuated collector tube 70, so that the evacuated collector tube 70 collects solar energy and turns it into heat.

A pipe 72 (usually copper but could be aluminium) extends into an interior of the evacuated collector tube 70 in a loop and emerges back out of the collector tube 70 through a seal 74.

The pipe 72 then extends to an aluminium or copper heat transfer block 76.

Heat transfer block 76 is typically in two parts so that it can be clamped both around pipe 72 and generator tube 78.

Pipe 72 is partially filled with liquid water. The remainder of the interior of the pipe 72 is filled with steam, which is at the saturation pressure of water at the temperature of the collector tube 70.

When the sunshine impinges on collector tube 70, the interior of the evacuated collector tube 70 heats up and the liquid water in the pipe 72 boils.

The generator 78 is cooler than the collector tube 70, and thus the saturated vapour pressure of the steam in contact with the pipe 72 inside the block will be lower than it is in the collector tube 70. The steam is transported by the vapour pressure difference from the collector tube 70 to the heat transfer block 76.

The steam condenses at the heat transfer block 76 and heats the block 76.

The condensed water in the pipe 72 then flows by gravity back to the portion of the pipe that is inside the collector tube 70.

As long as sunlight heats the collector tube 70, heat will be transferred to the generator 78.

FIG. 7b illustrates how the two-phase thermosyphon of FIG. 7a may function in a three-tube solar heat collector, for example a three-tube collector such as that illustrated in FIG. 1f. In this three-tube system, the same pipe 72 is passed through the interiors of the evacuated tubes 70 one after the other, so that the water is progressively heated to a higher and higher temperature. This arrangement may be particularly suitable for heating water where the required water flow rate means that the water cannot reach the required temperature inside a single evacuated tube.

Water is passed through pipes 72 (preferably copper tubes) in the interior of the top two evacuated collector tubes 70A and 70B (equivalent to 500A and 500B in FIG. 1f) first to progressively heat the water. The water then reaches an even higher temperature by being passed through the lower single collector tube 70C (equivalent to lower tube 500C in FIG. 1f).

Using this configuration of three-tubes 70A, 70B, 70C, the apparatus can advantageously reach higher efficiencies much more cheaply than is possible using only single heat-collector tubes.

FIG. 8 shows a solar cooker device 800 suitable for use with the solar thermal collector of the present invention. The solar cooker comprises a double-walled container, such as a cooking pot 810, which is shown inside an insulated box 820. The interior volume between the double walls of the container is arranged in a loop with a section of pipe (not shown) that passes through the interior of a solar heat collector tube. A heat vector may therefore flow between the interior of the solar heat collector tube and the interior volume of the container 810, so that food 830 may be placed in the container receives heat out of the container itself. The heat vector is preferably a two-phase thermosyphon as described above.

In preferred embodiments of the present invention, pairs of Fresnel reflectors and heat collector tubes are provided in discrete “units”, each pair forming a solar thermal heat collector assembly. Solar thermal heat collector modules may be provided by mounting a plurality of heat collector assemblies together on a module chassis or module frame. In a heat collector module, multiple heat collector assemblies are preferably mounted adjacent to one another in an array, preferably with adjacent assemblies touching one another so that any incident solar rays falling on the area of the module are reflected onto a solar heat collector tube by one of the Fresnel reflectors in the array.

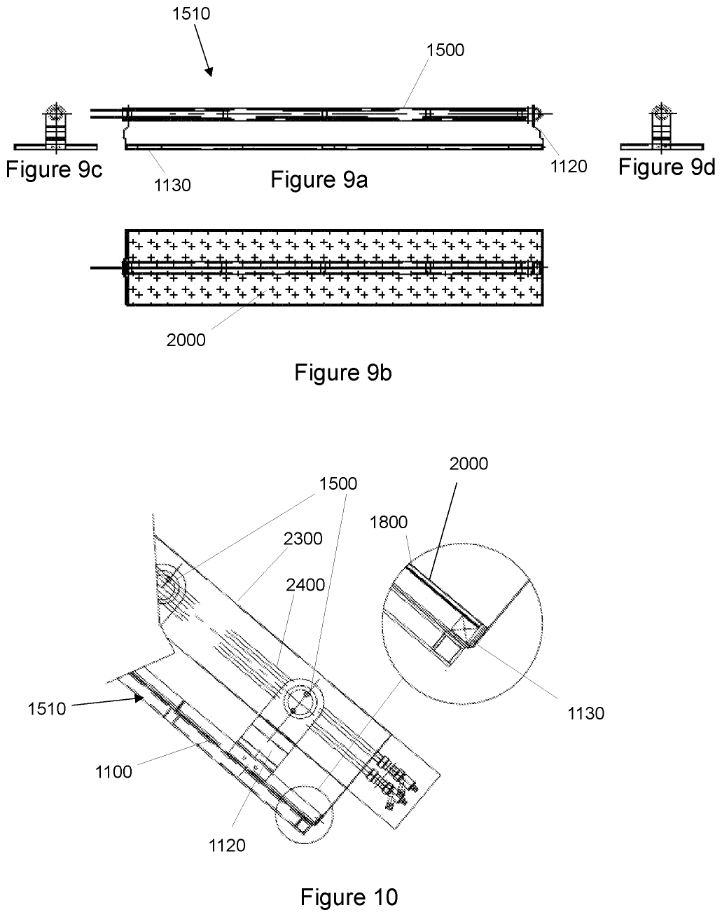

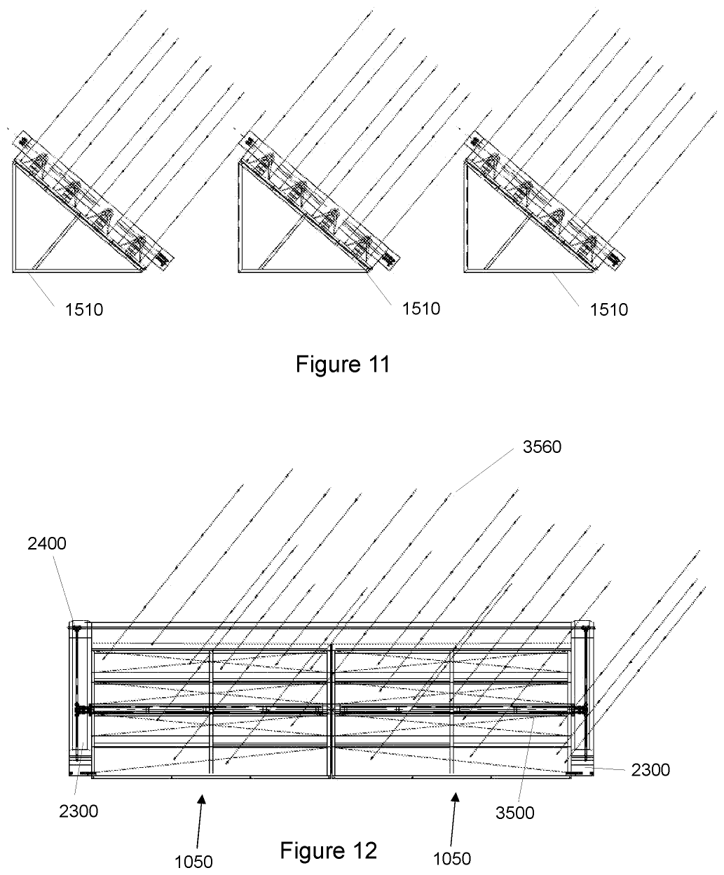

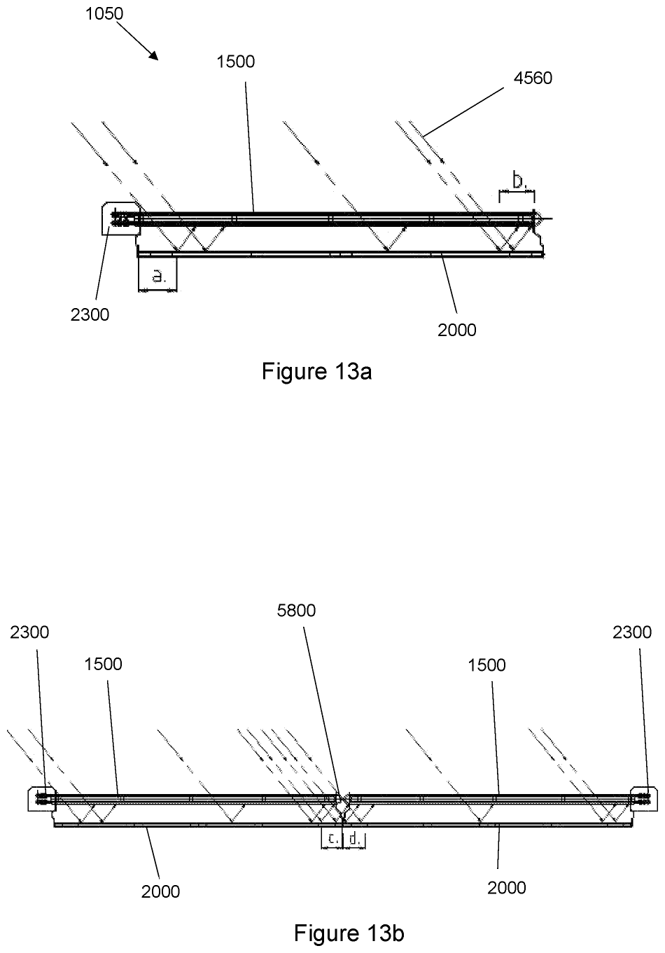

FIG. 9a-9d illustrate a solar thermal heat collector assembly 1050 according to the present invention, each heat collector assembly containing a Fresnel reflector and a solar heat collector tube according to the present invention, mounted together with an assembly frame.

The Fresnel reflector 2000 comprises the same features as the Fresnel reflector 1000 described above in relation to FIGS. 1a-1d, except where outlined below. The Fresnel reflector 2000 comprises an embossed Fresnel reflector film 1800 formed from an aluminium coated PET (polyester) film, which is bonded to the underside of a sheet of low iron toughened glass using acrylic adhesive.

An evacuated solar heat collector tube 1500 of the type commonly used to collect solar heat for solar hot water systems is used as a solar heat collector. In a preferred embodiment, the evacuated solar heat collector tube has a diameter of 50 millimetres.

The evacuated solar heat collector tube 1500 is supported above the Fresnel reflector 2000 by a frame 1100. The frame 1100 comprises a pair of end support brackets 1120, which suspend the ends of the evacuated solar heat collector tube 1500 at a predetermined height above the Fresnel reflector 2000, to maximise sun's focus focal point to Fresnel onto the Fresnel reflector 2000. The frame 1100 also comprises a tray 1130 which extends between the two end brackets 1120, and which forms a recess in which the Fresnel reflector 2000 is situated. The upper glass surface of the Fresnel reflector 2000 is situated flush with a top lip of the tray 1130, such that rainwater will wash away dust, dirt and debris.

In a preferred embodiment, the frame is formed from metal such as aluminium, particularly preferably the end brackets and tray are formed from pressed aluminium.

Together the Fresnel reflector 2000 (including its glass layer), the frame 1100 and the evacuated solar heat collector tube 1500 form the heat collector assembly 1050.

FIG. 10 is a partial end-on view of a solar thermal collector module containing two heat collector assemblies 1050 mounted on a module chassis 1510.

Multiple heat collector assemblies 1050 are mountable on a module chassis 1510, which may preferably be made from a metal such as steel. The module chassis 1510 is inclined at an angle to suit the latitude of the location of the apparatus. The chassis may be manufactured at a predetermined angle to suit the location of use, or the angle of the chassis may be adjustable. Each chassis and the heat collector assemblies mounted thereon form a heat collector module.

When multiple heat collector assemblies 1050 are mounted in an array as a heat collector module, an insulated manifold cover 2300 is positioned to cover at least a portion of a pipe system 2400. The pipe system conveys heated working fluid from the evacuated solar heat collector tubes 1500 to a hot fluid tank or other coil or absorption generator. A portion of the pipe or pipes 2400 that are retained within the evacuated solar heat collector tube 1500 is preferably retained, via pressed longitudinal clamps, against an inner surface of the evacuated solar heat collector tube 1500 wall, for maximum heat transfer from the evacuated solar heat collector tube 1500 to the pipe system 2400 and working fluid. The manifold cover 2300 may preferably be insulated aluminium and the pipe system 2400 is preferably formed from copper pipes.

FIG. 11 shows three heat collector modules, each supporting four heat collector assemblies 1050 on a module chassis 1510. The module placement is variable as to the quantity and placement, for example front to back and side by side, although consideration must be given so as to prevent one module from shadowing another module. The apparatus of FIG. 11 comprises 3 module chassis 1510, with predefined or adjustable angle setting of each individual module. The position of one module behind another is infinitely variable such that the module in front does not cast a shadow over the module behind, at the sun's highest rotation.

FIG. 12 shows a top view of a module consisting of two heat collector assemblies 1050 side by side. The assemblies are arranged with their two evacuated solar heat collector tubes 1500 arranged end to end, and their insulated covers 2300 and pipe manifolds 2400 positioned at opposite ends of the module, such that during the sun's daily rotation the shadows created from the insulated covers 2300 onto the evacuated solar heat collector tubes 3500 are minimised.

The arrangement of the two heat collector assemblies 1050 abutting one another end-to-end advantageously provides a large collector area of Fresnel reflector, and also means that early in the morning and late in the evening, as solar rays strike the Fresnel reflectors at a shallow angle, the Fresnel reflector of one module may advantageously reflect the incident rays onto the solar heat collector tube of the adjacent module. This provides improved heat collection at the beginning and end of the day, as solar power that would not be captured by an individual heat collector assembly can instead be captured by a nearby tube in the same module array.

FIG. 13a shows an apparatus comprising a single heat collector assembly 1050 including a Fresnel reflector 2000 and an evacuated solar heat collector tube 1500. FIG. 13a shows the sun rays 4560 acting upon the assembly. During the day, in the morning and afternoon, for an apparatus with only one module on its own, there will be a shadowed portion of the collector at area a, due to the insulated cover 2300 which houses the required pipe manifold. This means that there will be an unused portion of the incident solar rays at area b because they focus beyond the right-hand end of the collector tube 1500.

FIG. 13b is a schematic view of a heat collector module in which two heat collector assemblies 1050A (left-hand assembly) and 1050B (right-hand assembly) are arranged end-to-end. Advantageously, a clip 5800 or other fastener is provided to fasten the heat collector assemblies together at their abutted ends. As in FIG. 12, the heat collector assemblies 1050A, 1050B are oriented so that their pipe manifold covers 2300 are positioned at the outer edge of the module. This means that areas c and d are positioned adjacent to one another in the centre of the module.

In this arrangement, during times of day when solar rays are incident at a shallow angle, those rays that are incident on area c of the left-hand assembly 1050A are reflected and focused on area d of the solar collector tube in the right-hand assembly 1050B. This means that the rays falling on area c are not wasted as they would be in area b of the single assembly shown in FIG. 10a, because the Fresnel reflector in area c now focuses those incident rays onto the solar collector tube 1500 of the right-hand assembly 1050B. Over the course of a day this enhancement will gather considerably more heat in proportion to the total collector area than would be possible using single heat collector assemblies, or a single row of heat collector assemblies joined together along their long edges. This arrangement is also superior to module arrays containing a double row of heat collector assemblies with their manifold covers positioned between the rows.

It is emphasised that the particular systems that have been described and illustrated are just examples of an unlimited number of variations that are possible within the scope of the invention as defined by the accompanying claims.

1. Solar thermal collector comprising:
a solar heat collector tube; and
a Fresnel reflector film configured to focus incident solar light on the solar heat collector tube.

2. Solar thermal collector according to claim 1, in which the Fresnel reflector film is a concentrating linear Fresnel reflector, and in which the Fresnel reflector film is configured to focus solar light along a focal line on which the solar heat collector tube is positioned.

3. Solar thermal collector according to claim 1, in which the Fresnel reflector film is an embossed film, or a printed film.

4. Solar thermal collector according to claim 1, in which the Fresnel reflector film comprises an embossed region comprising a plurality of Fresnel optical elements, in which the embossed region has a thickness of between 5 μm and 25 μm.

5. Solar thermal collector according to claim 1, in which the Fresnel reflector film is covered by a transparent layer of glass, the layer of glass being positioned between the Fresnel reflector film and the solar heat collector tube.

6. Solar thermal collector according to claim 5, in which the Fresnel reflector film is bonded to the layer of glass by optically transparent adhesive.

7. Solar thermal collector according to claim 1, in which one side of the Fresnel reflector film comprises a reflective coating.

8. Solar thermal collector according to claim 1, in which the Fresnel reflector film has a focal length of between 120 mm and 300 mm, preferably between 140 mm and 250 mm, particularly preferably between 150 mm and 220 mm.

9. Solar thermal collector according to claim 1, in which the solar heat collector tube comprises an evacuated tube.

10. Solar thermal collector according to claim 9, in which the evacuated tube has a diameter of between 50 mm and 80 mm, preferably between 55 mm and 75 mm.

11. Solar thermal collector according to claim 1, comprising a secondary concentrator configured to focus incident light on the solar heat collector tube, the secondary concentrator being positioned on the opposite side of the solar heat collector to the Fresnel lens.

12. Solar thermal collector according to claim 11, in which the secondary concentrator comprises a second Fresnel reflector film.

13. Solar thermal collector according to claim 1, in which the solar heat collector tube is connected to a two-phase thermosyphon loop for transferring heat from the solar heat collector tube to a heat-receiving device.

14. Solar thermal collector according to claim 1, in which the solar heat collector tube contains a water pipe, and is configured to heat water flowing through the water pipe.

15. Solar thermal collector assembly, comprising:
a solar thermal collector according to claim 1, and
a frame configured to suspend the solar heat collector tube above the Fresnel reflector film.

16. A solar thermal collector module, comprising an array of solar thermal collector assemblies according to claim 15.

17. A solar thermal collector module according to claim 16, comprising two rows of solar thermal collector assemblies, in which pairs of adjacent solar thermal collector assemblies are positioned end-to-end such that the solar heat collector tubes of the assemblies are aligned along a common axis.

18. A solar thermal collector module according to claim 17, in which pipe manifolds of the respective solar thermal collector assemblies are located at the outer edges of the array.

19. A solar thermal collector module according to claim 16, comprising one or more fasteners for fastening together the frames of adjacent solar thermal collector assemblies in the array.

20. A cooling apparatus comprising:
a solar thermal collector according to claim 1; and
one or more absorption refrigeration modules, each module being arranged to receive heat from the solar heat collector tube for driving an absorption refrigeration cooling cycle.

21. Cooling apparatus according to claim 20, in which each module is configured to cool air in an air conditioning system.

22. Cooling apparatus according to claim 20, in which each module is arranged to cool air within an enclosed refrigerator cabinet.

23. Cooling apparatus according to claim 20, in which each module comprises:
a. a generator containing a solution of refrigerant in a liquid, the generator being arranged to receive heat from the solar heat collector tube and to cause evaporation of the refrigerant,
b. a bubble pump for pumping the liquid from the generator to an absorber,
c. a condenser arranged to receive gaseous refrigerant from the generator and to condense the same,
d. an evaporator,
e. means for passing liquid refrigerant from the condenser to the evaporator, and
f. absorbing means for receiving gaseous refrigerant from the evaporator, absorbing it into the liquid from the bubble pump and returning the liquid to the generator.

24. Cooling apparatus according to claim 23, in which each module comprises a heat pipe, the heat pipe being configured to transfer heat from the solar heat collector tube to the generator, preferably in which the heat pipe and the generator are in thermal contact via a heat store comprising a phase-change material.

25. Cooling apparatus according to claim 23, in which each module comprises a two-phase thermosyphon configured to transfer heat from the solar heat collector tube to the generator.

26. Use of a Fresnel reflector film to collect solar thermal energy in a solar thermal collector.

27. Use of a Fresnel reflector film according to claim 21, wherein the Fresnel reflector film focuses incident solar light on a solar heat collector tube.

28. A solar cooker:
comprising a solar thermal collector according to claim 1; and
a container for food, in which the solar cooker is configured to heat the container with heat from the solar heat collector tube.
